(19) United States
(12) Patent Application Publication
(10) Pub. No.: US 2025/0276902 A1
(43) Pub. Date: Sep. 4, 2025

(54) Carbon Nanotube End Cap Impregnated Multifunctional Catalyst

(71) Applicant: Michael Gurin, Glenview, IL (US)

(72) Inventor: Michael Gurin, Glenview, IL (US)

(21) Appl. No.: 19/211,211

(22) Filed: May 18, 2025

Related U.S. Application Data
(63) Continuation-in-part of application No. 18/398,108, filed on Dec. 27, 2023.
(63) Continuation-in-part of application No. 19/200,644, filed on May 6, 2025.

(51) Int. Cl. C01B 32/162; B01J 23/755; B01J 23/883; B01J 23/889; B01J 27/128; C04B 14/02; C04B 26/02; C04B 111/94; C08K 3/04

(52) U.S. Cl. CPC C01B 32/162; B01J 23/755; B01J 23/883; B01J 23/8892; B01J 27/128; C04B 14/026; C04B 26/02; C08K 3/041; C01B 2202/06; C01B 2202/22; C01B 2202/24; C01P 2006/32; C01P 2006/40; C04B 2111/94; C04B 2201/32; C08K 2201/001; C08K 2201/011

(57) ABSTRACT

A multifunctional end cap catalyst is provided, comprising a multi-wall carbon nanotube with a multi-metal catalyst at the end cap. The catalyst contributes preferentially to growing a multi-wall carbon nanotube through a methane pyrolysis process at a lower temperature, and then infuses the nanotube into a host material, such as concrete, asphalt, polymer, or steel, improving functional parameters including thermal conductivity, electrical conductivity, wettability, flexural strength, tensile strength, or interfacial bonding strength. The catalyst can also increase the host material's decrease phonon scattering or interfacial resistance, and lower the final defect density of the multi-wall carbon nanotube. The multifunctional end cap catalyst can be composed of various metals, including copper, nickel, and manganese, and can achieve specific functional states, such as oxidized or functionalized metal states, without increasing the final defect density.

### CROSS-REFERENCE TO RELATED APPLICATIONS

This application claims the priority benefit as a continuation in part from U.S. patent application Ser. No. 18/398,108 titled “Ultra-High Efficiency Hydrogen Hybrid Regenerative Thermodynamic System” on Dec. 27, 2023, and from U.S. patent application Ser. No. 19/200,644 titled “Non-Homogenous Thermocatalytic Gaseous Reactor” on May 6, 2025, the contents of which is incorporated by reference.

### BACKGROUND

Catalysts are substances that accelerate chemical reactions without being consumed or altered in the process. They work by lowering the activation energy required for the reaction to occur, allowing the reaction to proceed at a faster rate and with less energy input.

In the art of chemistry, catalysts are widely used to improve reaction yields, selectivity, and efficiency. They can be used to facilitate a wide range of chemical reactions, including:

1. Oxidation reactions: Catalysts such as palladium, platinum, and rhodium are commonly used in the oxidation of organic compounds.

2. Hydrogenation reactions: Nickel, palladium, and platinum are often used as catalysts in the hydrogenation of unsaturated compounds.

3. Polymerization reactions: Catalysts such as Ziegler-Natta agents and metallocene complexes are used to control the formation of polymers.

4. Fuel cell reactions: Platinum and iridium are used as catalysts in the electrochemical reactions of fuel cells.

5. Enzyme-catalyzed reactions: Biological catalysts such as enzymes are used to facilitate a wide range of biochemical reactions.

Catalysts can be classified into two main categories:

1. Homogeneous catalysts: These are catalysts that are in the same phase as the reactants, typically dissolved in a solvent.

2. Heterogeneous catalysts: These are catalysts that are in a different phase from the reactants, typically in the form of a solid or a gas.

The use of catalysts has numerous benefits in chemical synthesis, including:

1. Increased reaction rates

2. Improved reaction selectivity

3. Reduced reaction temperatures

4. Lower reaction energies

5. Increased product yields

Overall, catalysts play a crucial role in the art of chemistry, enabling the efficient and selective synthesis of a wide range of chemicals and materials. Clearly, the utilization of catalysts is well known in the art for a wide range of chemical reactions however the catalyst is designed and utilized for a singular function, then often leading to post-reaction separations requirements for reuse and/or economic recovery of the catalyst material particularly when the catalyst is an expensive platinum group metal “PGMs” or rare earth element “REEs” (both as known in the art) or final materials impregnation without any secondary function. There remains a need for catalysts that not only serve a function in the chemical reactivity for the production of a resulting chemical but further enhance at least one next process step in creating further value and reducing the requirement for catalyst removal (or the opportunity cost of not removing the catalyst for subsequent reuse or regeneration).

“Asphalt” refers to the host material into which the multi-wall carbon nanotube is infused, which is the industry standard asphalt as used on surface roads.

“At least one next process step” refers in most instances to the infusion of the multifunctional end cap catalyst, after an at least second process step, into a host material, such as concrete, asphalt, polymer, or steel, to enhance the host materials' functional parameters. The performance of the preceding at least second process step achieves enhanced performance as compared to multi-wall carbon nanotubes without the multifunctional end cap catalyst leading to subsequent enhanced performance up until the final process step (in most instances being the infusion of multifunctional end cap catalyst containing material into a host material).

“At least second process step” refers to the step after the first process step that being the original multi-metal catalyst achieving a primary catalytic reactivity ratio. The performance of the preceding at least second process step achieves enhanced performance as compared to multi-wall carbon nanotubes without the multifunctional end cap catalyst.

“Atomic percentage” refers to the mass of a particular element present in a material, expressed as a percentage of the total atomic weight of the material.

“Atomic weight” refers to the average mass of an atom of an element, which is a measure of the total mass of the atom's protons and neutrons.

“Catalytic reactivity ratio” refers to the ratio of the rates of reaction of a catalyst with different reactants. One instance is the ratio of hydrogen to carbon on a mass basis for unreacted gaseous reactants at the inlet cross section. Another instance is the ratio of hydrogen to carbon on a mass basis at the discharge cross section. This comparison of two instances provides a basis to compare the activity of the active catalyst within the non-homogenous thermocatalytic gaseous reactor.

“Chemical reactivity” refers to the ability of a substance to undergo a chemical change or reaction, including as exhibited by the multi-metal catalyst.

“Concrete” refers to a building material composed primarily of cement, water, and aggregate (such as sand, gravel, or crushed stone). In this context, the catalyst is being infused into concrete to improve its functional parameters, such as thermal conductivity, electrical conductivity, and mechanical strength.

“Electrical conductivity” refers to the ability of a material to conduct electricity. In the context of the multifunctional end cap catalyst, improved electrical conductivity refers to the ability of the infused multi-wall carbon nanotube to facilitate the flow of electric current.

“Electroless plating” refers to application of autocatalytic chemical reactions without electricity. A reducing agent (e.g., sodium hypophosphite) triggers metal ion reduction in a solution, depositing a uniform layer on both conductive and non-conductive surfaces.

“Electroplating process” refers to application of an external electrical current to deposit metal ions onto a conductive substrate. The substrate acts as the cathode, while the metal source serves as the anode in an electrolyte solution. When current flows, metal ions migrate and bond to the substrate's surface.

“End cap” refers to portion of a nanotube comprising a hemisphere-shaped end of a nanotube.

“Final defect density” refers to the number of structural or impurity defects present in a carbon nanotube or multi-wall carbon nanotube, typically measured as a percentage of the total number of nanotube atoms.

“Final process step” refers to infusing the multifunctional end cap catalyst containing material into a host material, such as concrete, asphalt, polymer, or steel, to achieve enhanced functional parameters beyond the catalytic reactivity ratio enhancement of the multifunctional end cap catalyst in the first process step.

“First metal” refers to the primary or initial metal component present in the multi-metal catalyst that retains its presence typically as a metal within the end cap of a multi-wall carbon nanotube, which contributes to the catalyst's role in growing and infusing the nanotube into the host material.

“First process step” refers to the process with the original multi-metal catalyst achieving a primary catalytic reactivity ratio. This is typically the growing of carbon nanotube or multi-wall carbon nanotube through a methane pyrolysis process at a lower temperature, using the multi-metal catalyst at the end cap of the multi-wall carbon nanotube.

“Flexural strength” refers to the ability of a material to withstand bending stress without failing, typically measured by the force per unit area required to cause a specified amount of bending deformation.

“Functional parameter” refers to a physical, chemical, or material property of a material that is affected by the presence of the multifunctional end cap catalyst, such as its thermal conductivity, electrical conductivity, or strength.

“Functionalized metal state” refers to a specific oxidation or chemical modification state of the metal component within the multi-metal catalyst, which can alter its properties and reactivity with limited creation of additional defects in the multifunctional end cap catalyst typically within a carbon nanotube or multi-wall carbon nanotube.

“Host material” refers to the material into which the multifunctional end cap catalyst, typically within a multi-wall carbon nanotube, is infused or embedded, such as concrete, asphalt, polymer, or steel.

“Host multi-metal mass” refers to the mass of the metal component(s) present in the host material (e.g. concrete, asphalt, polymer, or steel) to which typically the multi-wall carbon nanotube is infused, often in a metallic state, such as copper, nickel, and manganese.

“Initial multi-metal mass” refers to the total mass of the metal catalyst present at the end cap of the multi-wall carbon nanotube, prior to any changes or modifications that occurs after the first process step.

“Initial post-synthesis defect density” refers to the number of defects or impurities present in the multi-wall carbon nanotube after it has been synthesized (i.e., first process step), before any further processing or treatment (i.e., before at least second process step or at least one next process step).

“Interfacial bonding strength” refers to the measure of the adhesive properties between a material, such as a multi-wall carbon nanotube, and a host material, such as concrete or steel, where the nanotube is infused into the host material, indicating the strength of the bond between the two materials.

“Interfacial resistance” refers to the opposition to the flow of electrical current at the interface between the multi-wall carbon nanotube and the host material, such as concrete, asphalt, polymer, or steel, which can be reduced by the presence of the catalyst, leading to improved electrical conductivity and other functional properties.

“Length” refers to, in the context of multi-wall carbon nanotubes (MWCNTs), the axial dimension of the nanotube, typically measured in units of nanometers (nm), micrometers (m), or millimeters (mm) such that distance from the multifunctional end cap catalyst to the end cap of the multi-wall carbon nanotube is along the length of the multi-wall carbon nanotube.

“Location” refers to the point at which the multi-metal catalyst is within the multifunctional end cap catalyst and along the length of the multi-wall carbon nanotube.

“Metal to carbon ratio” refers to the proportion of metal catalyst present in the multi-wall carbon nanotube end cap relative to the amount of carbon in the nanotube, expressed as a ratio (e.g., weight percentage, atomic ratio, etc.).

“Methane pyrolysis process” refers to a thermal decomposition process in which methane is converted into carbon nanotubes and other products, typically involving the decomposition of methane in the presence of a catalyst at a methane pyrolysis temperature.

“Methane pyrolysis temperature” refers to the temperature at which methane is heated to decompose its molecules, typically in the absence of air, resulting in a controlled release of hydrogen and carbon atoms often at high temperatures, notably often above 800° C. without a catalyst especially without a multi-metal catalyst. The multi-metal catalyst preferentially enables methane pyrolysis process to occur below 650° C. and specifically below 600° C. (down to 400° C., though understood to be at any temperature along a continuum between 650° C. to 400° C. including 550° C., 500° C., or 450° C.).

“Multi-metal catalyst” refers to a composite material or system that combines two or more different metals or metal compounds operating as a catalyst as known in the art combining at least a first metal and a second metal.

“Multi-wall carbon nanotube” refers to a cylindrical structure composed of multiple hollow tubes, each with an inner diameter and wall thickness, formed by the rolling up of a sheet of carbon atoms in a specific pattern.

“Multi-wall metal catalyst phase change temperature” refers to the temperature at which the multi-metal catalyst in the end cap of the multi-wall carbon nanotube undergoes a phase change, often referred to as a transformation or oxidation, which can lead to changes in the catalyst's properties and reactivity.

“Multifunctional end cap catalyst” refers to a material composition, specifically a multi-wall carbon nanotube with a multi-metal catalyst, embedded at the end of a carbon nanotube such that enhanced performance is achieved at a first process step (primary function of the multi-metal catalyst) and additionally at least second process step, at least one next process step, and final process step such that the multi-metal catalyst provides superior performance in at least one of the intermediary steps resulting in superior performance of the host material that contains the multifunctional end cap catalyst as compared to a dedicated catalyst including a multi-metal catalyst not at a location within the end cap of the preferred multi-wall carbon nanotube.

“Oxidized metal state” refers to a surface modification of a metal, typically achieved through chemical treatment or exposure to air, which modifies a metal's interaction.

“Phonon mean free path” refers to the average distance that a phonon travels before it is scattered.

“Phonon scattering” refers to the scattering of lattice vibrations, or phonons, by impurities, defects, or irregularities in a material, resulting in an increase in thermal resistance, damping, and scattering of phonons.

“Plated metal” refers to a thin layer of metal, typically applied to the surface of a material, such as a multi-wall carbon nanotube, using electrochemical methods, where metal ions are reduced and deposited onto the surface, forming a thin layer of metal.

“Polymer” refers to a material consisting of a large molecule, or macromolecule, composed of long chains or networks of atoms, typically carbon-based, that are bonded together in a repeating pattern.

“Polymer chain alignment” refers to the phenomenon where the long, flexible molecular chains that make up a polymer are oriented in a preferential direction, often parallel to each other, rather than being randomly distributed. When polymer chains are aligned, the material exhibits anisotropic properties-meaning its mechanical, optical, and other characteristics differ depending on the direction in which they are measured. polymer chain alignment furthermore has an impact on functional parameters of the polymer. Without being bound by theory, this is due to the strong covalent bonds along the chain axis and weaker secondary bonds in the transverse direction, leading to significant directional dependence of properties like elastic modulus and birefringence. The process by which the ends of the multi-wall carbon nanotube are treated with the multifunctional end cap catalyst to improve its interaction with the host material further enhances polymer chain alignment, resulting in improved functional parameters including at least one of mechanical, thermal, and electrical properties of the composite host material.

“Rate of nucleation” refers to the number of nuclei of critical size that form per unit volume (or per unit area, depending on the context) per unit time in a system undergoing a phase transformation or self-organization process, such as in the preferred context that production rate of multi-wall carbon nanotubes at least partially encapsulating the multi-metal catalyst becoming the multifunctional end cap catalyst.

“Reactive powder concrete” refers to a type of concrete that is enhanced with a mixture of reactive powders, such as nanomaterials, to improve at least one of its functional parameters.

“Reduced metal state” refers to the condition in which a metal atom exists after it has gained electrons during a chemical reaction, resulting in a decrease in its oxidation state. In this state, the metal is in its elemental or a lower oxidation state form, as opposed to being in an oxidized (higher oxidation state) form

“Second metal” refers to a metal that is combined with the first metal, in this context to enhance the catalytic reactivity ratio as compared to catalytic reactivity ratio when the catalyst has only the first metal.

“Tensile strength” refers to the internal resistance to deformation or stretching, or the maximum stress that a material can withstand while being stretched or pulled before failing or breaking.

“Thermal conductivity” refers to the ability of a material to conduct heat, in this case, the multi-wall carbon nanotube within the host material, measured as the rate of heat flow per unit area, per unit length, and per unit temperature difference.

“Third metal” refers to another metal that is combined with the first metal and second metal, in this context to enhance the catalytic reactivity ratio as compared to catalytic reactivity ratio when the catalyst has only the first metal or only the first metal with second metal.

“Wettability” refers to the ability of a liquid to maintain contact with a solid surface, and it is controlled by the balance between the intermolecular interactions of adhesive type and cohesive type.

### BRIEF SUMMARY

A multifunctional end cap catalyst is provided first for the production of carbon nanotubes hereinafter also referred to as “CNT”, particularly for multi-wall carbon nanotubes hereinafter also referred to as “MWCNT” and for a wide range of secondary at least second process step and preferably even for an additional at least one next process step. The resulting multifunctional end cap catalyst consists of a multi-wall carbon nanotube with an embedded multi-metal catalyst, where the catalyst is located within the carbon nanotube and is positioned near the end cap.

The catalyst is used in at least two process steps: first, to grow the carbon nanotube preferably from a methane pyrolysis process, which lowers the methane pyrolysis temperature by a minimum of 200 degrees Celsius as compared to methane pyrolysis process without the multifunctional end cap catalyst; second, to infuse the carbon nanotube into a host material.

The catalyst has various properties that enhance its effectiveness, including:
The host multi-metal mass of the multi-metal catalyst increases by at least 2 percent a host material functional parameter, such as a rate of nucleation of a plated metal onto the carbon nanotube. In the instance of the host material being utilized for enhanced thermal conductivity or electrical conductivity, in particular, the initial multi-metal mass post synthesis of multi-wall carbon nanotubes has an initial multi-metal mass metal to carbon ratio of less than 1:5.
The plated metal increases by at least 2 percent a thermal conductivity, an electrical conductivity, or a wettability resulting from an electroless plating or an electroplating process.
The host material is a concrete, asphalt, polymer, or a combination of a concrete and a polymer, and contains the carbon nanotube with the multi-metal catalyst at the end cap.
The host material functional parameter is at least one parameter from the group of thermal conductivity, electrical conductivity, wettability, flexural strength, tensile strength, or interfacial bonding strength.

The catalyst can also have additional properties, such as:
The host multi-metal mass of the multi-metal catalyst decreases by at least 2 percent a phonon scattering or an interfacial resistance.
The carbon nanotube has an initial post-synthesis defect density and a final defect density immediately prior to adding the multi-metal catalyst into the host material, where the final defect density is lower by at least 5 percent.
The multi-metal catalyst comprises a first metal, a second metal, and a third metal, where the third metal is in a reduced metal state, an oxidized metal state, or a functionalized metal state.

The catalyst is specifically designed for use with certain metals, preferably such as copper, nickel, and manganese, and can have varying atomic percentages of these metals.

Additional metals are within the scope of this invention, predominantly as known in the art, though particularly preferred metals exclude PGMs and REEs due to economic limitations.

This summary is provided merely to introduce certain concepts and not to limit and identification of any or all key or essential features of the claimed subject matter.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates one embodiment of process steps with an indicative set of functional parameters corresponding to various process steps from multifunctional end cap catalyst through incorporation into a host material.

FIG. 2 illustrates the multi-wall carbon nanotube with integral multifunctional end cap catalyst.

### DETAILED DESCRIPTION

Here, as well as elsewhere in the specification and claims, individual numerical values and/or individual range limits can be combined to form non-disclosed ranges. Exemplary embodiments of the present invention are provided, which reference the contained figures. Such embodiments are merely exemplary in nature. Regarding the figures, like reference numerals refer to like parts.

As used herein the term “substantially” is used to indicate that exact values are not necessarily attainable. By way of example, one of ordinary skill in the art will understand that in some chemical reactions 100% conversion of a reactant is possible, yet unlikely. Most of a reactant may be converted to a product and conversion of the reactant may asymptotically approach 100% conversion. So, although from a practical perspective 100% of the reactant is converted, from a technical perspective, a small and sometimes difficult to define amount remains. For this example of a chemical reactant, that amount may be relatively easily defined by the detection limits of the instrument used to test for it. However, in many cases, this amount may not be easily defined, hence the use of the term “substantially”. In some embodiments of the present invention, the term “substantially” is defined as approaching a specific numeric value or target to within 20%, 15%, 10%, 5%, or within 1% of the value or target. In further embodiments of the present invention, the term “substantially” is defined as approaching a specific numeric value or target to within 1%, 0.9%, 0.8%, 0.7%, 0.6%, 0.5%, 0.4%, 0.3%, 0.2%, or 0.1% of the value or target.

As used herein, the term “about” is used to indicate that exact values are not necessarily attainable. Therefore, the term “about” is used to indicate this uncertainty limit. In some embodiments of the present invention, the term “about” is used to indicate an uncertainty limit of less than or equal to +20%, +15%, +10%, +5%, or +1% of a specific numeric value or target. In some embodiments of the present invention, the term “about” is used to indicate an uncertainty limit of less than or equal to +1%, +0.9%, +0.8%, +0.7%, +0.6%, +0.5%, +0.4%, +0.3%, +0.2%, or +0.1% of a specific numeric value or target. {Alternatively—As used herein, the term “about” or “approximately” can mean within an acceptable error range for the particular value as determined by one of ordinary skill in the art, which can depend in part on how the value is measured or determined, e.g., the limitations of the measurement system. For example, “about” can mean within I or more than I standard deviation, per the practice in the art. “About” can mean a range of ±20%, ±10%, ±5%, or ±I % of a given value. Where particular values are described in the application and claims, unless otherwise stated, the term “about” means within an acceptable error range for the particular value. The term “about” can have the meaning as commonly understood by one of ordinary skill in the art. The term “about” can refer to ±10%. The term “about” can refer to ±5%.}

As used herein, the term “optional” or “optionally” means that the subsequently described event or circumstance can or cannot occur, and that the description includes instances where the event or circumstance occurs and instances where it does not.

It is understood that throughout this specification the identifiers “first” and “second” are used solely to aid the reader in distinguishing the various components, features, or steps of the disclosed subject matter. The identifiers “first” and “second” are not intended to imply any particular order, amount, preference, or importance to the components or steps modified by these terms. However, the identifiers “next” is intended to imply a particular order and importance to the components or steps modified by this term. To further clarify, next specifically implies when associated with a first instance is prior to the next second instance with respect to time sequence (recognizing that often a first instance can be followed not only by a second instance but also a third or even fourth instance) such that next explicitly implies that the step is realized for the first instance prior to the second instance (or third instance). The identifiers “previous” and “prior” is intended to imply a particular order and importance to the components or steps modified by this term. To further clarify, previous specifically implies when associated with a previous first instance is prior to the second instance with respect to time sequence (recognizing that often a third instance can be preceded not only by a second instance but also a first instance) such that previous (or prior) explicitly implies that the step is realized for the first instance prior to the second instance (or third instance).

A preferred embodiment is a multifunctional end cap catalyst that is utilized within a carbon nanotube growing process comprised such that nanotube at least partially encapsulates the multifunctional end cap catalyst. A particularly preferred carbon nanotubes are multi-wall carbon nanotubes with the multifunctional end cap catalyst having at least one metal with both electrical conductivity and thermal conductivity respectively greater than 2.17×10 \hat{ }6 S/m and 15-25 W/(m-K). The particularly preferred multi-wall carbon nanotube, which is comprised of an end cap and a length of the multi-wall carbon nanotube and the multi-metal catalyst, has the multi-metal catalyst within a location no greater than 5 percent of the length of the multi-wall carbon nanotube from the end cap of the multi-wall carbon nanotube. The multi-metal catalyst contributes to a first process step growing the multi-wall carbon nanotube on the multi-metal catalyst and thus becoming a multifunctional end cap catalyst, preferably from a methane pyrolysis process where the methane pyrolysis temperature is lower than the multi-wall metal catalyst phase change temperature. The multi-metal catalyst has an initial multi-metal mass during the methane pyrolysis process and the resulting multi-wall carbon nanotubes with the embedded multi-metal catalyst in the end cap of the multi-wall carbon nanotube is subsequently added to a host material. It is understood that prior to the multifunctional end cap catalyst in the multi-wall carbon nanotube being added to the host materials the multifunctional end cap catalyst can preferentially undergo at least one at least second process step. A primary inventive feature is that the multi-metal catalyst performs better by at least 2% (and preferably at least 5%, and particularly preferred at least 10%, and specifically preferred at least 20%) better for at least one of the at least second process step or the at least one next process step as compared to solely the multi-metal catalyst without being embedded into the multi-wall carbon nanotube or the multi-metal catalyst not being embedded into the multi-wall carbon nanotube at a location in proximity to the end cap within the host multi-metal mass host material. The term proximity to the end cap, as used within, is a distance between the multi-metal catalyst and the end cap of the multi-wall carbon nanotube (it is understood that single wall carbon can be substituted for each instance referring to a multi-wall carbon nanotube) of no greater than 50 micron (and preferred no greater than 20 micron, particularly preferred no greater than 10 micron, and specifically preferred no greater than 100 nanometer.

The functional parameter of the host material in which the multifunctional end cap catalyst within the multi-wall carbon nanotubes includes at least one of thermal conductivity, electrical conductivity, electroless plating effectiveness, electroplating process effectiveness, wettability within the host materials, tensile strength, interfacial bonding strength, and flexural strength. In this embodiment the preferred initial multi-metal mass metal to carbon ratio is less than 1:5.

The multi-metal catalyst is first within the multi-wall carbon nanotube and then within the host multi-metal mass following the methane pyrolysis process. The amount of remaining multi-metal catalyst prior to mixing with the host material is at least 5% of the initial multi-metal mass of the multi-metal catalyst. The multi-metal catalyst lowers the multi-wall carbon nanotube growth temperature on the multi-metal catalyst by a minimum of 200 degrees Celsius as compared to the multi-wall carbon nanotube growth temperature without the multi-metal catalyst. It is understood that the multi-metal catalyst can be partially removed, by methods as known in the art, such that the initial multi-metal mass is reduced by at least 10% (and preferably at least 20%, particularly preferred at least 50%) but less than 98% (therefore not requiring high-purity for the multi-wall carbon nanotube when utilized within at least one of the at least second process step or at least one next process step). Yet the inventive multifunctional end cap catalyst increases the effectiveness of at least one of the functional parameters by at least 2% (and preferably at least 5%, and particularly preferred at least 10%, and specifically preferred at least 20%) better within the at least one of the at least second process step or the at least one next process step as compared to solely the multi-metal catalyst without being embedded into the multi-wall carbon nanotube or the multi-metal catalyst not being embedded into the multi-wall carbon nanotube at a location in proximity to the end cap within the host multi-metal mass host material.

Without being bound by theory, the same multifunctional end cap catalyst within the multi-wall carbon nanotube has a higher catalytic reactivity ratio by at least 2% (and preferably at least 5%, and particularly preferred at least 10%, and specifically preferred at least 20%) than the same multi-metal catalyst as compared to solely the multi-metal catalyst without being embedded into the multi-wall carbon nanotube or the multi-metal catalyst not being embedded into the multi-wall carbon nanotube at a location in proximity to the end cap within the host multi-metal mass host material. The higher catalytic reactivity ratio is achieved without having to create final defect density on the multi-wall carbon nanotubes.

The multi-metal catalyst when at least 5 percent of the initial multi-metal mass of the multi-metal catalyst remains in the multi-wall carbon nanotubes contributes to the effectiveness of a host material at least one functional parameter within at least one next process step wherein the at least one next process step is to infuse the multi-wall carbon nanotubes into the host material as a final process step. The final process step can be either an at least second process step prior to the at least one next process step or the same as the at least one next process step. The host multi-metal mass of the multi-metal catalyst also increases by at least 2 percent at least one host material functional parameter as compared to the host material functional parameter with the host multi-metal mass having less than 5 percent of the initial multi-metal mass of the multi-metal catalyst remaining in the multi-wall carbon nanotubes.

A preferred host material functional parameter includes a rate of nucleation of a plated metal onto the multi-wall carbon nanotube when the plated metal is at least second process step or at least one next process step, or final process step consisting of electroless plating or electroplating process or reduction of a metal salt infused on the multi-wall carbon nanotubes. Another particularly preferred host material functional parameter is the improvement by at least 2 percent (preferably at least 5 percent, and particularly preferred at least 15 percent) of thermal conductivity, an electrical conductivity, or a wettability resulting from an electroless plating or an electroplating process. Without being bound by theory, having at least 5 percent of the multi-metal catalyst remaining within the multi-wall carbon nanotube as a multifunctional end cap catalyst enhances at least one of electron, phonon, and plasmon transport in addition to phonon-plasmon coupling within the host material functional parameter. Without being bound by theory, the multi-metal catalyst within the end cap of the multi-wall carbon nanotubes (i.e., multi-metal catalyst being a multifunctional end cap catalyst) provides superior interaction of the resulting metal being applied via electroless plating or electroplating process or reduction of a metal salt infused on the multi-wall carbon nanotubes as the at least second process step, further leading to superior interaction of the multi-wall carbon nanotubes in the host material through subsequent at least one next process step.

Yet another host material functional parameter includes enhancement of flexural strength of the host material, a tensile strength of the host material, or an interfacial bonding strength of the multi-wall carbon nanotube with the host material. The term enhancement used throughout without an immediately following characterization of enhancement is an increase by at least 2 percent (preferably at least 5 percent, and particularly preferred at least 15 percent) of at least one respective host material functional parameter.

Another critical set of host material functional parameters where performance enhancement is a reduction (and not an increase) by at least 2 percent (preferably at least 5 percent, and particularly preferred at least 15 percent) of at least one respective host material functional parameter includes phonon scattering, interfacial resistance, final defect density immediately prior to adding the multi-metal catalyst within the multi-wall carbon nanotubes then subsequently added into the host material.

A fundamental benefit of the multifunctional end cap catalyst is the functionalized metal state enabling a superior interaction of the multi-wall carbon nanotubes into the host material as compared to the functionalization of the multi-wall carbon nanotubes by increasing the final defect density of the multi-wall carbon nanotubes. It is known in the art on chemical cross-linking to metals therefore enabling superior interaction of the multi-wall carbon nanotubes via the multifunctional end cap catalyst. The inventive method of explicitly using the multifunctional end cap catalyst for effective functionalization of the multi-wall carbon nanotubes yields benefits for a wide range of host materials including concrete (notably the preferred reactive powder concrete), asphalt, polymers (notably the preferred polymers with polymer chain alignment, and particularly preferred highly crystalline polymers). Another preferred host material is a composite of concrete combined with a polymer where both the concrete and the polymer contain the multi-wall carbon nanotubes with the multi-metal catalyst at the end cap of the multi-wall carbon nanotubes. Additional host materials are metals including steel, aluminum, titanium, copper, silver, gold, or a metal alloy containing steel, aluminum, titanium, copper, silver, gold and any combination with steel, aluminum, titanium, copper, silver, gold, or any third metal not already inclusive of steel, aluminum, titanium, copper, silver, and gold.

A particularly preferred embodiment of the multifunctional end cap catalyst has the multi-metal catalyst comprising a first metal and a second metal, such that the first metal or the second metal is in a functionalized metal state after the first process step, such that the presence of either the first metal or the second metal at the end cap of the multi-wall carbon nanotubes achieves the functionalized metal state without increasing the final defect density as compared to the final defect density in the absence of the first metal and the second metal at the end cap. Maintaining at least one metal from the multi-metal catalyst at the end cap of the multi-wall carbon nanotubes enables the aforementioned enhancements (as noted either increase or decrease with their respective host material functional parameters) to be achieved with all things equal a lower final defect density. Another embodiment has the multi-metal catalyst comprising a first metal, a second metal, and a third metal where the third metal is in a reduced metal state, oxidized metal state or a functionalized metal state.

Another embodiment has the multi-metal catalyst having two metals, a first metal and a second metal in which either the first metal or the second metal is in an oxidized metal state or a functionalized metal state after the first process step such that the presence of either the first metal or the second metal at the end cap increases by at least 5 percent higher a chemical reactivity for either the oxidized metal state or the functionalized metal state as compared to the chemical reactivity in the absence of the first metal and the second metal at the end cap. The increased chemical reactivity is realized in at least second process step, at least one next process step, or final process step.

A specifically preferred catalyst has three distinct metals, notably comprised of copper “Cu”, nickel “Ni” and manganese “Mn”, and a specifically preferred catalyst has the approximate atomic ratio of Cu55Ni44Mn1. It is understood that the relative ratio between the individual metals remains as anticipated within the “approximate” terminology to as much as a plus or minus 10 percent variance from the indicated approximate atomic ratio. The addition of manganese enhances the catalytic reactivity ratio, without being bound by theory as realized in at least second process step, at least one next process step, or final process step.

Alternative third metals include iodine, aluminum in the functionalized metal state of AlN, and molybdenum in the functionalized metal state of MoS2.

Another embodiment has the multi-metal catalyst having two metals, a first metal and a second metal in which either the first metal or the second metal is in an oxidized metal state or a functionalized metal state after the first process step such that the presence of either the first metal or the second metal at the end cap increases by at least 5 percent higher a polymer chain alignment for either the oxidized metal state or the functionalized metal state as compared to the polymer chain alignment in the absence of the first metal and the second metal at the end cap. Preferred variations include the third metal having an atomic percentage less than 5 percent of a total multi-metal catalyst atomic weight. Another preferred variation has the first metal with an atomic percentage at least 5 percent higher than the second metal within the total multi-metal catalyst atomic weight. Yet another preferred variation has either the first metal or the second metal at least partially transformed from the reduced metal state to the oxidized metal state, without being bound by theory, such that a phonon mean free path is increased by at least 5 percent as compared to neither the first metal or the second metal being transformed from the reduced metal state to the oxidized metal state. The close proximity of the one metal being in a reduced metal state (i.e., conductive) and the other metal being in an oxidized metal state (i.e., semi-conductive) while both being nanoscale materials (e.g., less than 100 nm in diameter, preferably less than 50 nm, and particularly preferred less than 10 nm). It is particularly critical for the semi-conductive metal to be less than 20 nm and specifically preferred less than 10 nm in diameter.

Yet another embodiment includes an initial multi-metal mass metal to carbon ratio lower than 1:5 (preferably lower than 1:15, and specifically lower than 1:50 yet also including lower than 1:6, 1:7, 1:8, 1:10, 1:20, 1:25, 1:30, 1:35, 1:40, and 1:45) into a host material. A host material being predominantly the same metal as either the first metal or the second metal, such that the final metal to carbon ratio following the final process step, such that the final metal to carbon ratio, which is the aggregate metal mass of the initial multi-metal mass plus or minus and change in metal mass due to all changes of metal mass resulting from an at least second process step, an at least one next process step and a final process step is lower than 10:1 and particularly preferred lower than 1:1, and specifically preferred lower than 1:2, yet also including lower than 9:1, 8:1, 7:1, 6:1, 5:1, 4:1, 3:1, 2:1, 1:1, 1:3, 1:4, and 1:5). The host material has at least one functional parameter enhanced by the multi-wall carbon nanotubes containing the multifunctional end cap catalyst by at least 2 percent as compared to the host material at least one functional parameter with approximately equivalent mass fraction of multi-wall carbon nanotubes without the multifunctional end cap catalyst. Approximately equivalent in this instance is within plus or minus 5 percent (preferably within plus or minus 4 percent, or 3 percent, or 2 percent, or 1 percent) of multi-wall carbon nanotubes mass between the two scenarios depicted.

Another embodiment includes an initial multi-metal mass metal to carbon ratio lower than 1:5 (preferably lower than 1:15, and specifically lower than 1:50 yet also including lower than 1:6, 1:7, 1:8, 1:10, 1:20, 1:25, 1:30, 1:35, 1:40, and 1:45) into a host material. A host material being predominantly a metal that isn't either the first metal, second metal, or third metal, such that the final metal to carbon ratio following the final process step, such that the final metal to carbon ratio, which is the aggregate metal mass of the initial multi-metal mass plus or minus and change in metal mass due to all changes of metal mass resulting from an at least second process step, an at least one next process step and a final process step is lower than 10:1 and particularly preferred lower than 1:1, and specifically preferred lower than 1:2, yet also including lower than 9:1, 8:1, 7:1, 6:1, 5:1, 4:1, 3:1, 2:1, 1:1, 1:3, 1:4, and 1:5). The host material has at least one functional parameter enhanced by the multi-wall carbon nanotubes containing the multifunctional end cap catalyst by at least 2 percent as compared to the host material at least one functional parameter with approximately equivalent mass fraction of multi-wall carbon nanotubes without the multifunctional end cap catalyst. Approximately equivalent in this instance is within plus or minus 5 percent (preferably within plus or minus 4 percent, or 3 percent, or 2 percent, or 1 percent) of multi-wall carbon nanotubes mass between the two scenarios depicted.

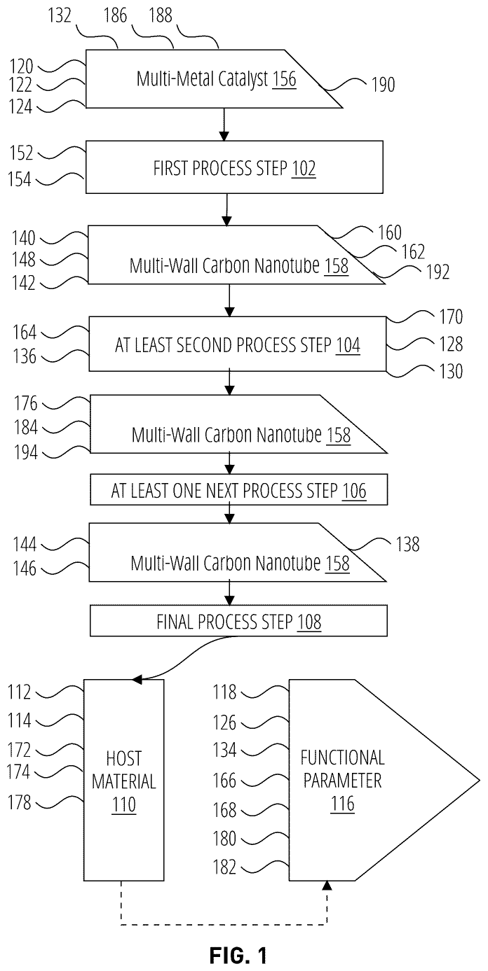

Turning to FIG. 1, FIG. 1 depicts an exemplary process model combined with linkage of functional parameters 116 throughout the process of starting from a first process step 102 to an at least second process step 104 followed by an at least one next process step 106 and ultimately to a final process step 108. A multi-metal catalyst 156 having atomic percentage 120, atomic weight 122, catalytic reactivity ratio 124, first metal 132 and a second metal 186 and an optional third metal 188, and at least one of the first metal 132, second metal 186, or third metal 188 being in a reduced metal state 190.

The first process step 102, in the preferred embodiment of growing multi-wall carbon nanotubes 158 is a methane pyrolysis process 152 operating at a preferred methane pyrolysis temperature 154 as known in the art leveraging the multi-metal catalyst 156. The resulting multi-wall carbon nanotube 158 has an initial multi-metal mass 140, length 148, initial post-synthesis defect density 142, and a multi-wall metal catalyst phase change temperature 160.

The resulting multi-metal catalyst 156 becomes a multifunctional end cap catalyst 162 such that the multifunctional end cap catalyst 162 is positioned approximately at the end cap 192 of the multi-wall carbon nanotube 158.

An exemplary at least second process step 104 is executed on the resulting multi-wall carbon nanotube 158 including transforming at least one of the metals selected from the group of first metal 132, second metal 186, or option third metal 188 (not shown in this figure) is exposed to oxygen to become in an oxidized metal state 164, is exposed to a cross-linking chemical (as known in the art) to become in an functionalized metal state 136, or is applied either an electroless plating 128 or electroplating process 130 to further increase the metal to carbon ratio 204 and thus to have a plated metal 170. The multi-wall carbon nanotube 158, following the at least second process step 104, is characterized now rate of nucleation 176, wettability 184, and chemical reactivity 194.

Now an optional at least one next process step 106 is implemented to then result in a modified multi-wall carbon nanotube 158 characterized by interfacial bonding strength 144, interfacial resistance 146, and host multi-metal mass 138.

A now final process step 108 is implemented in which the resulting multifunctional end cap catalyst 162 within the multi-wall carbon nanotube 158 are incorporated into a host material 110. The host material 110 is characterized by a range of functional parameters 116 including: a final defect density 118, an atomic percentage 120, an atomic weight 122, a catalytic reactivity ratio 124, an electrical conductivity 126, flexural strength 134, host multi-metal mass 138, phonon mean free path 166, phonon scattering 168, tensile strength 180, thermal conductivity 182, and/or wettability 184.

The host material 110 can be a wide range of materials including: asphalt 112, concrete 114, polymer 172 (having a polymer chain alignment 174), or reactive powder concrete 178, and though not shown in this figure virtually any metal including metals selected from the group of first metal 132, second metal 186, and though not preferred third metal 188.

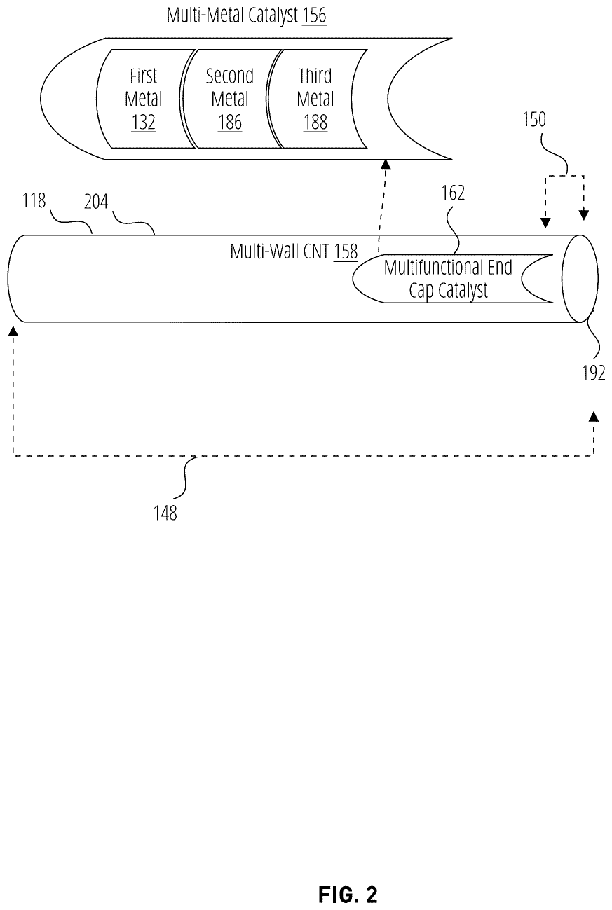

Turning to FIG. 2, FIG. 2 is a multi-wall carbon nanotube 158 having a length 148, comprises a multi-metal catalyst 156 with a location 150 in close proximity to the end cap (becoming the distance from the end cap 192 to the location 150 of the multi-metal catalyst 156 of the multi-wall carbon nanotube 158 thus becoming a multifunctional end cap catalyst 162. The multi-metal catalyst is comprised of a first metal 132 and a second metal 186 and an optional third metal 188, again when located in the multi-wall carbon nanotube 158 in close proximity to the end cap 192 of the multi-wall carbon nanotube 158 is a multifunctional end cap catalyst 162. The multi-wall carbon nanotube 158 has a final defect density 118 and a metal to carbon ratio 204 preferably lower than 1:5, particularly preferred lower than 1:10, and specifically preferred lower than 1:15.

While the invention has been described in connection with various embodiments, it will be understood that the invention is capable of further modifications. This application is intended to cover any variations, uses or adaptations of the invention following, in general, the principles of the invention, and including such departures from the present disclosure as, within the known and customary practice within the art to which the invention pertains.

What is claimed is:

1. A multifunctional end cap catalyst comprised of a multi-wall carbon nanotube having a multi-metal catalyst wherein the multi-wall carbon nanotube has an end cap and a length of the multi-wall carbon nanotube, the multi-metal catalyst having a location within the multi-wall carbon nanotube wherein the location of the multi-metal catalyst is within no greater than 5 percent of the length of the multi-wall carbon nanotube from the end cap of the multi-wall carbon nanotube, whereby the multi-metal catalyst contributes to a first process step wherein the first process step is to grow the multi-wall carbon nanotube from a methane pyrolysis process having a methane pyrolysis temperature lower than a multi-wall metal catalyst phase change temperature, whereby the multi-metal catalyst has an initial multi-metal mass during the methane pyrolysis process, whereby the multi-metal catalyst has a host multi-metal mass following the methane pyrolysis process whereby the host multi-metal mass is at least 5 percent of the initial multi-metal mass of the multi-metal catalyst, whereby the multi-metal catalyst lowers the methane pyrolysis temperature by a minimum of 200 degrees Celsius as compared to the methane pyrolysis temperature without the multi-metal catalyst, whereby the multi-metal catalyst contributes to an at least one next process step wherein the at least one next process step is to infuse the multi-wall carbon nanotube into a host material as a final process step whereby the final process step can be either an at least second process step prior to the at least one next process step or the same as the at least one next process step, and whereby the host multi-metal mass of the multi-metal catalyst also increases by at least 2 percent a host material functional parameter as compared to the host material functional parameter with the host multi-metal mass when at least 5 percent of the initial multi-metal mass of the multi-metal catalyst remains in the multi-wall carbon nanotubes.

2. The multifunctional end cap catalyst of claim 1 whereby the host multi-metal mass of the multi-metal catalyst also increases by at least 2 percent a host material functional parameter as compared the host material functional parameter with the host multi-metal mass less than 5 percent of the initial multi-metal mass of the multi-metal catalyst, wherein a rate of nucleation of a plated metal onto the multi-wall carbon nanotube is the host material functional parameter, and whereby the plated metal increases by at least 2 percent a thermal conductivity, an electrical conductivity, or a wettability resulting from an electroless plating or an electroplating process.

3. The multifunctional end cap catalyst of claim 1 whereby the host material is a concrete or an asphalt.

4. The multifunctional end cap catalyst of claim 3 whereby the concrete is a reactive powder concrete.

5. The multifunctional end cap catalyst of claim 1 whereby the host material is a polymer, whereby the multi-metal catalyst within the multi-wall carbon nanotube has a metal to carbon ratio greater than 1:5.

6. The multifunctional end cap catalyst of claim 1 whereby the host material is a concrete combined with a host material of a polymer, whereby both the concrete and the polymer contain the multi-wall carbon nanotube further comprised of the multi-metal catalyst at the end cap.

7. The multifunctional end cap catalyst of claim 1 whereby the host material is steel, aluminum, titanium, copper, silver, gold, or a metal alloy containing steel, aluminum, titanium, copper, silver, gold and any combination with steel, aluminum, titanium, copper, silver, gold, or any third metal not already inclusive of steel, aluminum, titanium, copper, silver, and gold.

8. The multifunctional end cap catalyst of claim 1 whereby the host material functional parameter is at least one parameter from the group of a thermal conductivity, an electrical conductivity, a wettability of the multi-wall carbon nanotube within the host material, a flexural strength of the host material, a tensile strength of the host material, or an interfacial bonding strength of the multi-wall carbon nanotube with the host material.

9. The multifunctional end cap catalyst of claim 1 whereby the host multi-metal mass of the multi-metal catalyst also decreases by at least 2 percent a phonon scattering or an interfacial resistance as compared to the host material without the multifunctional end cap catalyst within the multi-wall carbon nanotube.

10. The multifunctional end cap catalyst of claim 1 whereby the multi-wall carbon nanotube has an initial post-synthesis defect density and a final defect density immediately prior to adding the multi-metal catalyst into the host material, and whereby final defect density is lower by at least 5 percent when the host multi-metal mass of the multi-metal catalyst is at least 5 percent of the initial multi-metal mass as compared to when the host multi-metal mass of the multi-metal catalyst is at less than 5 percent of the initial multi-metal mass.

11. The multifunctional end cap catalyst of claim 10 whereby the multi-metal catalyst comprises a first metal and a second metal, whereby either the first metal or the second metal is in a functionalized metal state after the first process step, and whereby the presence of either the first metal or the second metal at the end cap achieves the functionalized metal state without increasing the final defect density as compared to the final defect density in the absence of the first metal and the second metal at the end cap.

12. The multifunctional end cap catalyst of claim 1 whereby the multi-metal catalyst comprises a first metal, a second metal, and a third metal whereby the third metal is in a reduced metal state or an oxidized metal state or a functionalized metal state.

13. The multifunctional end cap catalyst of claim 1 whereby the multi-metal catalyst comprises a first metal and a second metal, whereby either the first metal or the second metal is in an oxidized metal state or a functionalized metal state after the first process step, and whereby the presence of either the first metal or the second metal at the end cap increases by at least 5 percent higher a chemical reactivity for either the oxidized metal state or the functionalized metal state as compared to the chemical reactivity in the absence of the first metal and the second metal at the end cap.

14. The multifunctional end cap catalyst of claim 1 whereby the multi-metal catalyst comprises a first metal and a second metal, whereby either the first metal or the second metal is in an oxidized metal state or a functionalized metal state after the first process step, and whereby the presence of either the first metal or the second metal at the end cap increases by at least 5 percent higher a polymer chain alignment for either the oxidized metal state or the functionalized metal state as compared to the polymer chain alignment in the absence of the first metal and the second metal at the end cap.

15. The multifunctional end cap catalyst of claim 12 whereby the first metal is copper, the second metal is nickel.

16. The multifunctional end cap catalyst of claim 12 whereby the third metal is manganese.

17. The multifunctional end cap catalyst of claim 12 whereby the third metal is iodine, aluminum in the functionalized metal state of AlN, molybdenum in the functionalized metal state of MoS2.

18. The multifunctional end cap catalyst of claim 16 wherein the third metal has an atomic percentage less than 5 percent of a total multi-metal catalyst atomic weight.

19. The multifunctional end cap catalyst of claim 15 wherein the first metal has an atomic percentage at least 5 percent higher than the second metal within the total multi-metal catalyst atomic weight.

20. The multifunctional end cap catalyst of claim 15 wherein the first metal atomic percentage is approximately 55, wherein the second metal atomic percentage is approximately 44, and wherein the third metal atomic percentage is approximately 1.

21. The multifunctional end cap catalyst of claim 15 whereby either the first metal or the second metal is at least partially transformed from the reduced metal state to the oxidized metal state, and whereby a phonon mean free path is increased by at least 5 percent as compared to neither the first metal or the second metal being transformed from the reduced metal state to the oxidized metal state.
